(19) United States
(12) Patent Application Publication
(10) Pub. No.: US 2010/0162960 A1
(43) Pub. Date: Jul. 1, 2010

(54) Automatic Livestock Feeder System

(76) Inventor: Glen D. Moon, Bluffdale, UT (US)

Correspondence Address: Malone Intellectual Property, 3992 Mammoth Cave Loop, Dumfries, VA, 22025, US

(21) Appl. No.: 12/549,331

(22) Filed: Aug. 27, 2009

Related U.S. Application Data
(60) Provisional application No. 61/204,033, filed on Dec. 31, 2008.

(51) Int. Cl. A01K 5/02; G06F 17/00

(52) U.S. Cl. 119/51.02; 119/57.1; 119/51.11; 700/231

(57) ABSTRACT

An automatic livestock feeder system is disclosed. A vertical lifting means lifts feed allowing livestock to feed through feed bars. An electronic timer allows for automatic feeding on a timed schedule in a standalone mode. Livestock are feed automatically based on a timed schedule or an event based schedule. Historical livestock feeding habits are recorded and stored remotely.

### PRIORITY CLAIM

This application claims priority to provisional application 61/204,033 filed Dec. 31, 2008, which is herein incorporated by reference.

### BACKGROUND

### Field of the Invention

This invention relates to animals and livestock such as horses, cattle and other domestic animals, which eat hay, grains or pelletized food. Specifically it addresses a concern of animal owners as to how to feed their animals in their absence.

### SUMMARY OF THE INVENTION

It has been recognized that it would be advantageous to develop an automatic livestock feeder system capable of storing and dispensing grains, hay, pelletized food, food supplements, and medications. In addition, it has been recognized that it would be advantageous to develop a feeder system capable of operating in remote locations. In addition, it has been recognized that it would be advantageous to develop a feeder system with block programming capability. Furthermore, it has been recognized that it would be advantageous to develop a feeder system with various electronic reporting features such as historical food consumption, real-time storage monitoring, livestock eating habits, and feeder system error reporting. Furthermore, it has been recognized that it would be advantageous to develop a feeder system with RFID (radio frequency identification) input functionality.

The invention provides an automatic livestock feeder system and apparatus for storing and automatically dispensing grains, hay, pelletized food, food supplements, and medications to various kinds of livestock. The feeder apparatus includes: a mechanical means for lifting feed to be consumed by livestock; a timer mechanism capable of block programming and for sending an input signal to the mechanical lifting means; and a housing structure for storing and supporting the distribution of feed to livestock. An additional feature of the feeder system includes a communication means for communicating with the Internet, servers, databases, and computers.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1 is a front view of a housing structure in accordance with an embodiment of the present invention;

FIG. 2a is a top view of multiple area feeder bars in accordance with an embodiment of the present invention;

FIG. 2b is a top view of single area feeder bars in accordance with an embodiment of the present invention;

FIG. 3a is a side view of a lifting means in a feed position in accordance with an embodiment of the present invention;

FIG. 3b is a side view of a lifting means in accordance with an embodiment of the present invention;

FIG. 4 is a flow diagram of the automatic feeder system with various features in accordance with an embodiment of the present invention;

### DETAILED DESCRIPTION OF EXAMPLE EMBODIMENT(S)

### Description

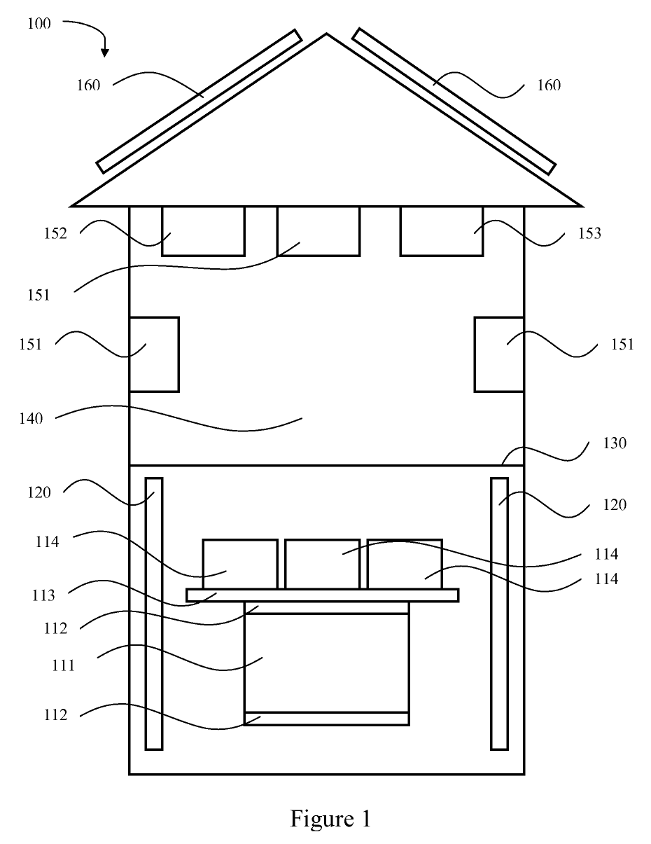

As illustrated in FIG. 1, the feeder housing (100) includes an upper section (140) that is open for livestock feeding, a food storage area between the feeding bars (130) and the bottom of the feeder housing, a lifting means (111), a feed tray (113), and a roof to cover and protect feeding and storage areas. On the roof are optional solar collectors (160) used to charge a battery (not shown). The battery may be located in the attic area of the feeder housing or in the lower section of the feeder housing. For convenience the feeder load door is not shown in FIG. 1. The feeder load door is position so as to cover the area where the feed is stored including from the feeder bar (130) to the bottom of the feeder housing.

To load the feeder the load door is opened and the lifting means (111) is lowered to allow for loading feed onto the feed tray (113).

To feed, livestock approach the open section (140) and enter the feeder housing with their head and feed through the feed bars (130). The feed bars restrict the livestock from eating all of the food from the feed tray (113) by allowing only a certain distance for the livestock's snout to protrude through the feed bars (130) due to the width of the feed bars. The feed tray (113) is shown with livestock food (114). Below the feed tray (113) is a lifting means (111). The lifting means (111) has optional load cells (112) above and/or below for weighing livestock food (114) as it is stored on the feed tray (113) and for weighing food individual animals have eaten. The lifting means (111) lifts the feed tray (113) into a proximate position for livestock feeding. The lifting means (111) is controlled by an electronic device (not shown) which may be positioned anywhere within the housing structure. The electronic device may be relays, microprocessors, computers, timer mechanisms, programmable logic controllers, or any electronic device known in the art of electronic control devices. The electronic device may use sensors (120) for detecting position of the feed, feed tray (113), and/or for detecting the position of the lifting means (111). The sensors (120) may be any kind of sensor known in the art of electrical controls such as: capacitive, inductive, optical, mechanical, etc. The electronic device may also have network connectivity for controlling, monitoring, and reporting feeder system features. Network connectivity may be accomplished through cellular networks, local networks, satellite networks, wired networks, wireless networks, POTS wired systems, mesh networks, Bluetooth, or any other wired or wireless communication technology known in the art of communication. The network may be a local area network, a wide area network, and/or the Internet. The lifting means (111) may be electro-mechanically powered by electric motors, gasoline, diesel, or propane engines, hydraulic lifts, pneumatic lifts, or any other lifting means known in the art of linear motion. Additionally, lifting means (111) may incorporate: pulleys, rams, screw drives, lever mechanisms, scissor lifts, or any other known method of mechanical lifting.

A grain dispenser (152) dispenses grain into the feed area in addition to the feed on the feed tray. Medication dispenser (153) dispenses medications or supplements onto the feed in the feed tray. The grain dispenser and medication dispenser may be located anywhere in or on the feeder housing and are shown in FIG. 1 on the ceiling for illustration purposes only. RFID interrogator(s) (151) may be placed on or around feeding areas as needed for communicating with passive livestock RFID tags.

In one embodiment the feeder system works in a standalone mode. In this mode, an electronic timer device is preprogrammed onsite to lift the feed tray (113) toward the feed bars at preprogrammed time intervals allowing livestock or other animals to eat a fixed amount of food from the feed tray. The standalone mode may be used with or without RFID capability.

In another embodiment the feeder system works in a networked mode. In this mode, a computer or microprocessor (electronic device) is placed within the feeder housing. The electronic device is connected to a network for programming, reporting, and two-way communication with auxiliary services. The networked mode may be also used with or without RFID capability.

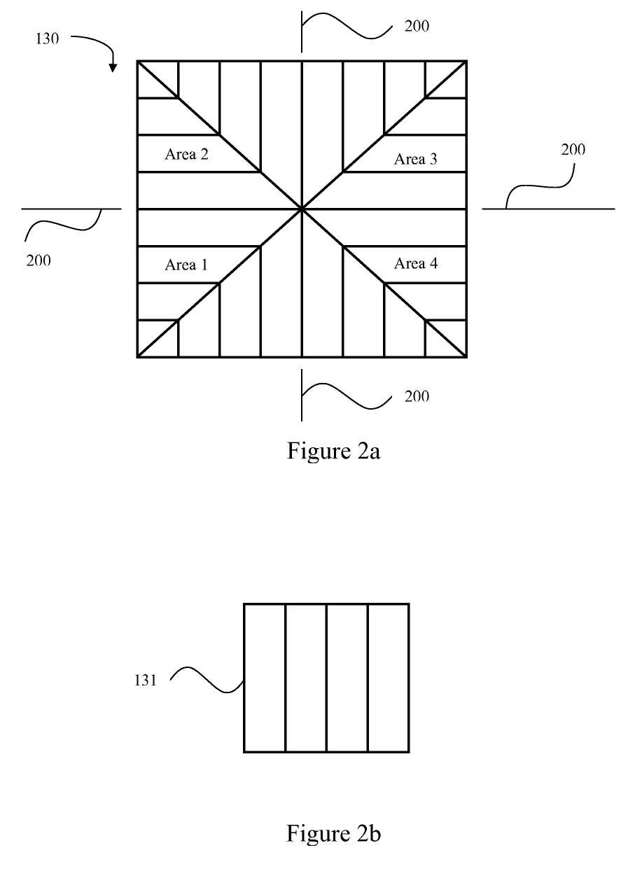

As illustrated in FIG. 2a, the feeder bars (130) are shown in an arrangement with four distinct areas. Each area is separated by a fence (200). The fence allows different animals or kinds of animals to feed in separated areas. For example, a pasture may have four fenced off areas with a feeder place at an intersection of the fenced areas allowing for feeding of animals in each of the four fenced areas from the same feeder. The feeder system could be equipped with multiple feed trays and lifting means within one single housing structure. Each area could store different types of food for various animals. The feeder bars are spaced at an appropriate distance to allow the livestock to feed between the bars when the feed tray is lifted to a proper distance. FIG. 2b shows a simple feed bar configuration made for a single lifting means. The feeder bars may be positioned in any shape or form allowing for animal feeding.

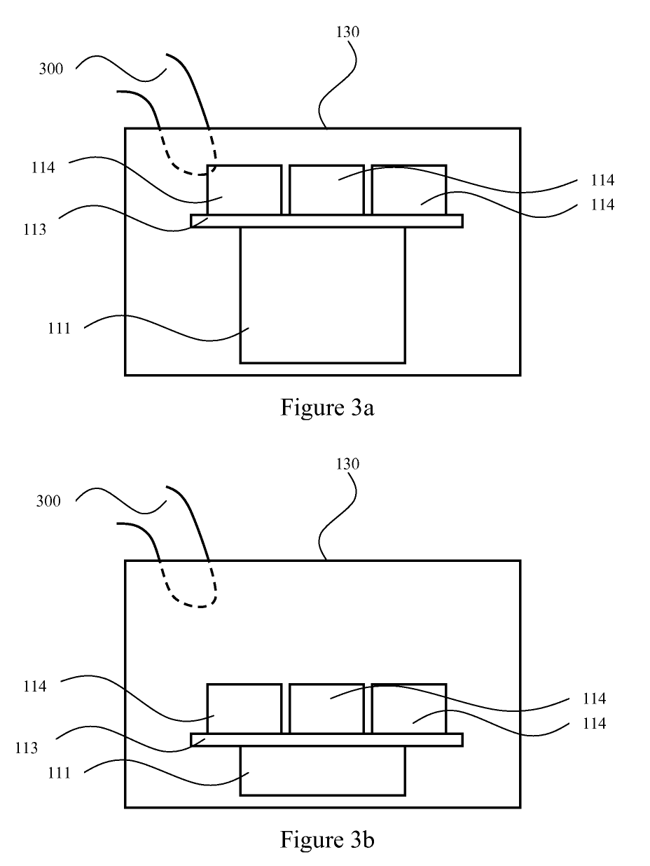

FIG. 3a shows a feed tray (113) lifted to an appropriate distance for an animal (300) to feed through the feed bars (130). The feed tray (113) may be configured to hold various types of feed. Such configurations may include groves for directing feed into a certain pattern or position in accordance with the feeder bar patterns in order to enable efficient dispensing of the feed to livestock. Other configurations may include a patterned tray optimized for dispensing a certain type of feed such as hay or pellets or grain.

FIG. 3b shows a feed tray (113) lowered to a position where an animal (300) cannot reach the feed (114). The animal (300) may wear an RFID tag as an input to the feeder system. The feed tray (113) may lower based on a specific animal eating a certain weight of food over a given time period thus controlling the amount of food a specific animal eats.

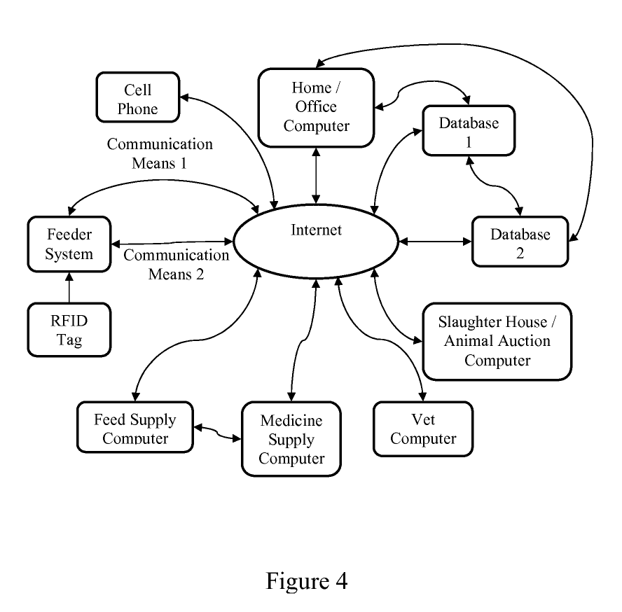

FIG. 4 shows a flow diagram of the feeder system with various features. Each animal is equipped with its own RFID tag as an input to the feeder system. The feeder system is equipped with an RFID interrogator as an input to an electronic device within the feeder system. An electronic device within the feeder system communicates with a network. An optional second electronic device within the feeder system also may communicate with a network. Databases 1 and 2 are coupled to the feeder system through a network. The network may be one or more of a local area network, a wide area network, the Internet, a mesh network, a cellular network, a wired telephone network, and/or a satellite network. A cellular telephone may be connected directly to the feeder system through a cellular network, the Internet, or a local area network. Additionally, a cellular telephone may be connected directly to the feeder system through a Bluetooth phone connection. The cellular phone could work as a wireless remote control device for unlocking the feeder system to refill feed or medicine. After connecting with the feeder system an unlock code could be entered into the cell phone unlocking the feeder thus allowing easy feeder access to pharmacies, food stocking companies, or the owners of the animals. The Internet provides two-way communication between the feeder system and home/office computers, multiple databases, multiple servers, slaughter house computers, animal auction computers, veterinarian computers, medicine supply computers, feed supply computers, cellular telephones, and animal monitoring service computers. In one embodiment, the feeder system may store locally or in a remote database records pertaining to each individual animal's eating habits, cost of food consumed, type of food consumed, amount of food consumed, cost of medicines, types of medicines, amounts of hormones or medicines, types of hormones, and report this information to government agencies, animal auction computers, or slaughter house computers at the time the animal is sold or on a routine basis. The record would be made based on RFID tag registration by an electronic device located within the feeder system. The livestock could be associated with a specific RFID tag and the weight of food allotted for the specific animal or the specific food or medicine consumed by the specific animal allowing individual records to be made based on livestock feeding habits. In another embodiment, the feeder system may communicate with a feed supply computer informing the feed supply company that the feed needs to be refilled. The feeder system may communicate a unique identifier along with the request for more food to the feed supplier that allows the feed supplier to bill the feed system owner or bill a credit card of the feed system owner automatically. The feeder system may also request restocking of medicines or hormones from a medicine supplier and if necessary a request may automatically be sent to a veterinarian for a prescription refill. The feeder system owner may have access to the feeder system computer from his home computer and establish settings for automatically communicating with databases and auxiliary services and alarm reporting. Auxiliary services may include: feed suppliers, medicine suppliers, animal auction databases, governmental agencies, veterinarians, and/or livestock monitoring services. The feeder system may be configured to send automatic notifications as emails or text messages to computers or cell phones. The notifications may be based on the times and dates specific animals are eating. The feeder system may be configured to sound an audible signal when feed is available for animals to eat. The audible signal may be the owner's voice calling to the animals or the sound of the owner's vehicle played to attract the animals to the feed area. This would allow the animal owners to get the animals on a specific eating schedule. The feeder system may be equipped with video security around the feeding areas. In the event that the feeder system detects food loss without a valid RFID registration the feeder system may sound an alarm to scare off small rodents and birds that may get into the feeder housing. The detection of unwanted animals may be a result of: the load cell or cells sensing a weight loss or gain without the feeder housing load doors being open and without the feed tray being in a feed position, sensors within the feeder housing, internal video monitoring, or external video monitoring. The feeder system may be configured to: call preprogrammed phone numbers and give recorded messages, send predetermined email messages, or send predetermined text messages based on certain circumstances such as low electrical power conditions, mechanical problems detected, food shortages, animals that have not eaten in a given time period, etc.

In an embodiment of the present invention, a horse fitted with a passive RFID device approaches the feeder system after hearing a prerecorded message played of his owner's voice. The horse knows it is time to eat and approaches the feeder. When the horse's head sticks inside of the feeder system the feeder system recognizes the horse and, based on predetermined settings that the owner of the horse set from his home computer, moves the feed tray into a feeding position and dispenses a programmed amount grain into the food and also dispenses a programmed amount of medication on the horse's food. When the predetermined amount of food is eaten the feed tray is automatically lowered and the horse is done feeding.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. An automatic livestock feeder system, comprising:
a feeder housing capable of storing and dispensing feed, the feeder housing including at least one open side where livestock can enter and feed from within the feeder housing;
a feed tray positioned inside the feeder housing and at an elevation lower than that of the at least one open side;
a lifting means positioned beneath the feed tray and inside of the feeder housing for lifting the feed tray;
an electronic device for controlling the lifting means based on one or more conditions; and
an electrical power source for causing the lifting means to move and the electronic device to function.

2. A livestock feeder system in accordance with claim 1, wherein the one or more conditions consist of a timed event.

3. A livestock feeder system in accordance with claim 1, wherein the one or more conditions consist of an RFID (radio frequency identification) tag communication.

4. A livestock feeder system in accordance with claim 1, wherein the electrical power source is a battery.

5. A livestock feeder system in accordance with claim 1, wherein the electrical power source is a hydrogen fuel cell.

6. A livestock feeder system in accordance with claim 1, further comprising:
a grain dispenser positioned within the feeder housing and above the feed tray for dispensing grain based on said one or more conditions.

7. A livestock feeder system in accordance with claim 1, further comprising:
a medication dispenser for dispensing medication or supplements based on said one or more conditions.

8. A livestock feeder system in accordance with claim 1, wherein the electronic device is a computer.

9. A livestock feeder system in accordance with claim 1, wherein the electronic device communicates with one or more databases over the Internet.

10. A livestock feeder system in accordance with claim 1, wherein the electronic device is programmable by a remote computer over a network.

11. An automatic livestock feeder system, comprising:
a feeder housing capable of storing and dispensing feed, the feeder housing including at least one open side where livestock can enter and feed from within the feeder housing;
a feed tray positioned inside the feeder housing and at an elevation lower than that of the at least one open side;
a lifting means positioned beneath the feed tray and inside of the feeder housing for lifting the feed tray;
a computer for controlling the lifting means based on one or more conditions;
an electrical power source for causing the lifting means to move and the computer to function; and
at least one interrogator located in or near the feeder housing and communicatively coupled to the computer.

12. A livestock feeder system in accordance with claim 11, wherein the one or more conditions consist of a timed event.

13. A livestock feeder system in accordance with claim 11, wherein the one or more conditions consist of an RFID (radio frequency identification) tag communication.

14. A livestock feeder system in accordance with claim 11, wherein the electrical power source is a battery.

15. A livestock feeder system in accordance with claim 11, wherein the electrical power source is a hydrogen fuel cell.

16. A livestock feeder system in accordance with claim 11, further comprising:
a grain dispenser positioned within the feeder housing and above the feed tray for dispensing grain based on said one or more conditions.

17. A livestock feeder system in accordance with claim 11, further comprising:
a medication dispenser for dispensing medication or supplements based on said one or more conditions.

18. A livestock feeder system in accordance with claim 11, wherein the computer automatically transmits historical feeding data to remote databases or remote computers.

19. A livestock feeder system in accordance with claim 11, wherein the computer communicates with one or more databases over the Internet.

20. A livestock feeder system in accordance with claim 11, wherein the computer is programmable by a remote computer over a network.
